(19) United States
(12) Patent Application Publication
(10) Pub. No.: US 2024/0198838 A1
(43) Pub. Date: Jun. 20, 2024

(54) SYSTEMS AND METHODS FOR MANAGING CHARGING SESSIONS IN VEHICLES

(71) Applicant: Cummins Inc., Columbus, IN (US)

(72) Inventors: Uday Subramaniam, Columbus, IN (US); Gajendran Bakthavachalam, Columbus, IN (US); Sathya Narayanan Hariharan, Columbus, IN (US); Denisse Alejandra Meza Soria, Columbus, IN (US); Soniya Makarand Deshpande, Columbus, IN (US); Scott Allen Rittenhouse, Nashville, IN (US); Richard A. Booth, Columbus, IN (US); Joseph E. Paquette, Columbus, IN (US)

(21) Appl. No.: 18/512,417

(22) Filed: Nov. 17, 2023

Related U.S. Application Data
(60) Provisional application No. 63/433,687, filed on Dec. 19, 2022.

(51) Int. Cl. B60L 53/62; B60L 53/66

(52) U.S. Cl. CPC B60L 53/62; B60L 53/66

(57) ABSTRACT

A charge system and corresponding method for maintaining an available state-of-charge above a predetermined threshold during an extended charging session and/or restarting a charging session if said charging session terminates and the resulting available state-of-charge remains below the predetermined threshold. Additionally, a charge system and corresponding method for tracking metrics of a charge session to allow for accessibility in reviewing and/or troubleshooting charging session-related events.

### CROSS-REFERENCE TO RELATED PATENT APPLICATIONS

This application claims the benefit of and priority to U.S. Provisional Application No. 63/433,687, filed on Dec. 19, 2022, the disclosure of which is hereby incorporated herein by reference in its entirety.

### TECHNICAL FIELD OF THE PRESENT DISCLOSURE

The present disclosure relates to methods for maintaining, restarting, and tracking charge sessions in electric and/or hybrid vehicles. The present disclosure further relates to diagnosing faults and/or errors occurring during such charging sessions.

### BACKGROUND OF THE PRESENT DISCLOSURE

Electric and/or hybrid vehicles are often left connected to a corresponding charger for long periods of time; for example, such vehicles may be left connected to a corresponding charger overnight or another extended time period between vehicle usage events. Conventionally, charging sessions end when the battery or batteries of the corresponding vehicle reaches top-of-charge or when the session is interrupted by error or fault before top-of-charge is reached. Although the vehicle may remain connected to the charger, the charging session does not resume or restart after ending unless the charger is disconnected and reconnected.

This means that if the session ends due to a fault or error before reaching top-of-charge, an operator may return to the vehicle and find the vehicle is not at full charge. In other scenarios, the vehicle's high voltage battery or batteries may have reached top-of-charge, resulting in the end of the charging session, but then began to discharge due to parasitic power drawn by accessories. Because the session does not resume or restart without intervention, the operator may return to the vehicle and find the vehicle is not at full charge, regardless of reaching top-of-charge during the initial charging session, which may result in delayed operation due to an additional waiting period until top-of-charge is reached and general displeasure at finding the vehicle at a lower state-of-charge than expected or desired. In other scenarios, the charge controller unit may continue depleting the low voltage battery once the powertrain controller shuts down after a charging session ends with the charger left connected to the vehicle, and the powertrain is no longer available to regulate the low voltage battery. Any of these scenarios may leave the vehicle at a significantly lower state-of-charge or lower low voltage battery voltage than required to complete the subsequent vehicle usage event, resulting in delay of the vehicle usage event while a new charging session is attempted and/or cancellation of the vehicle usage event.

The reason for a charging session termination is not always apparent or discernible. Because of the quick succession of events that occurs once a charging session ends, it is difficult or impossible to determine what reason caused termination of the charge session. In many scenarios, the charging session may end without an accompanying fault code—either because such fault code does not exist or because termination of the charging session was intentional through, i.e., releasing a parking brake, manually disconnecting the charger, or other operator action that may end the charging session. As a result, chronic charging issues may be difficult or impossible to diagnose.

### SUMMARY OF THE DISCLOSURE

The present disclosure provides a charging system and corresponding method for maintaining an available state-of-charge above a predetermined threshold during an extended AC charging session, preventing low voltage battery drain when a charging session terminates, and/or restarting an AC charging session if said charging session terminates and the resulting available state-of-charge remains below the predetermined threshold. The present disclosure further provides a charging system and corresponding method for tracking metrics of a charging session to allow for accessibility in reviewing and/or troubleshooting charging session-related events.

In a first aspect of the disclosure, a charging system for restarting an AC charging session is disclosed. The charging session comprises a controller. The controller is configured to receive a first input identifying a charge session interruption; receive a second input identifying an available state-of-charge of a battery; compare the available state-of-charge of the battery with a predetermined threshold; and transmit a first output to command a first attempt to restart the charge session when the available state-of-charge of the battery is less than the predetermined threshold.

In a second aspect of the disclosure, a charging system for mitigating low voltage battery depletion is disclosed. The charging system comprises a controller. The controller is configured to receive a first input identifying a charge session termination; receive a second input identifying an available state-of-charge of a battery; compare the available state-of-charge of the battery with a predetermined threshold; and when the available state-of-charge of the battery is higher than the predetermined threshold, transmit a first output commanding a charging control unit to retain an auxiliary keyswitch input to a powertrain control module to inhibit shutdown of the powertrain control module.

In a third aspect of the disclosure, a charging system for tracking metrics of a charging session is disclosed. The charging system comprises a controller and a memory. The controller is configured to receive a first input identifying a failure of a charging session; execute a stateflow that uses sequential decision logic or if/else logic loops to identify a reason for the failure of the charging session; and record the reason for the failure of the charging session in the memory with readable text.

In various aspects of the disclosure, the controller may be configured to continuously receive the second input identifying the available state-of-charge of the battery.

In various aspects of the disclosure, when a first attempt to restart the charge session fails, the controller may be configured to allow a calibratable amount of time to lapse before transmitting a second output to initiate a second attempt to restart the charge session. The controller may be configured to feed a hardcoded false output to an interface parameter for the calibratable amount of time. When the second attempt to restart the charge session fails, the controller may be configured to allow shutdown of a powertrain control module.

In various aspects of the disclosure, the controller may be configured to transmit a second output commanding contactors of the battery to remain closed.

In various aspects of the disclosure, the controller may be configured to transmit a third output commanding a DC-DC converter to regulate a low voltage battery voltage at a predetermined setpoint.

In various aspects of the disclosure, the controller may be configured to continuously receive the first input identifying the available state-of-charge of the battery. The controller may be configured to identify an event in which the available state-of-charge of the battery is depleted beneath the predetermined threshold. The controller may be configured to transmit a fourth output to attempt to restart the charge session when the available state-of-charge of the battery is less than the predetermined threshold.

In various aspects of the disclosure, the failure of the charging session may be result of an unexpected termination of the charging session.

In various aspects of the disclosure, the controller may be configured to further identify at least one of: a charging session type, a charging session number, a duration of an active charging session, a net state-of-charge change, a duration of active charge, a measurement of net energy delivered into high voltage batteries, a duration of connection to a charger, a duration of delay of the charging session, and a duration of discharge. The controller may be configured to identify ten metrics of the charging session. The controller may be configured to record the metrics in an array.

In various aspects of the disclosure, the charging system may further comprise a user interface configured to access the memory and display readable text. The user interface may be configured to display the readable text for a plurality of vehicles.

In various aspects of the disclosure, the controller may be configured to transmit a first output to attempt restart of the charging session.

In various aspects of the disclosure, the charging system may further include a plug having a locked position and an unlocked position, wherein the plug is in the locked position when the controller transmits the first output.

In various aspects of the disclosure, the charging system may be configured to operate with a fuel cell electric vehicle. The charging system may be configured to operate with a fleet of fuel cell electric vehicles.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 is a schematic block diagram of a vehicle system;

FIG. 2 illustrates a schematic arrangement of a charging system configured to execute one or more methods for maintaining an available state-of-charge above a predetermined threshold and/or track and record metrics of a charging session;

FIG. 3 is a graph illustrating an available state-of-charge course during a charging session, including a plurality of points at which the charging session may terminate, while using a charging system configured to maintain the available state-of-charge above a predetermined threshold;

FIG. 4 illustrates a method for maintaining the available state-of-charge above a predetermined threshold;

FIG. 5 illustrates a method for tracking and recording metrics of a charging session;

FIG. 6 illustrates the result of use of the charging system of FIG. 2 over a 24-hour period;

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

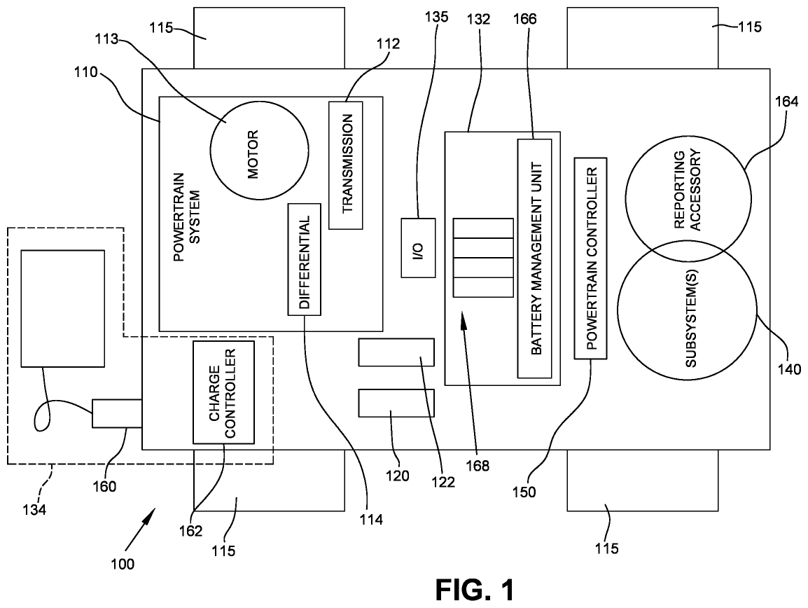

Referring initially to FIG. 1, a schematic diagram of a battery electric vehicle 100 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 100 may be operable in at least one of a reverse direction (e.g., a backward direction relative to a front end of battery electric vehicle 100) and a non-reverse direction (e.g., a forward direction, angular direction, etc., relative to the front end of battery electric vehicle 100). Battery electric vehicle 100 may be an on-road or off-road vehicle including, but not limited to, cars, trucks, ships, boats, vans, airplanes, spacecraft, or any other type of vehicle.

Battery electric vehicle 100 comprises a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Battery electric vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 facilitates power transfer from a battery 132 and/or a motor 113 to power battery electric vehicle 100. In an exemplary embodiment, powertrain system 110 includes motor 113 operably coupled to battery 132 and charge system 134, where motor 113 transfers power to a final drive (e.g., wheels 115) to propel battery electric vehicle 100. As depicted, powertrain system 110 may include other various components, such as a transmission 112 and/or differential 114, where differential 114 transfers power output from transmission 112 to final drive 115 to propel battery electric vehicle 100. Powertrain controller 150 of battery electric vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system, rechargeable battery, etc.). In some embodiments, electricity provided to power motor 113 may be provided by an onboard gasoline-engine generator, a hydrogen fuel cell, etc.

In some embodiments, battery electric vehicle 100 may include transmission 112. Transmission 112 may be structured as any type of transmission compatible with battery electric vehicle 100, including a continuous variable transmission, a manual transmission, an automatic transmission, an automatic-manual transmission, or a dual clutch transmission, for example. Accordingly, as transmissions vary from geared to continuous configurations, transmission 112 may include a variety of settings (e.g., gears, for a geared transmission) that affect different output speeds based on an engine speed or motor speed. Like transmission 112, motor 113, differential 114, and final drive 115 may be structured in any configuration compatible with battery electric vehicle 100. In some embodiments, transmission 112, is omitted and motor 113 is directly coupled to differential 114. In other embodiments, motor 113 is directly coupled to final drive 115 as a direct drive application. In some examples, battery electric vehicle may comprise multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 100). Generally, brake mechanism 120 is configured to receive an indication of a desired change in the vehicle speed. In some embodiments, brake mechanism 120 comprises a brake pedal operable between a released state and an applied state by an operator of battery electric vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance. Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 100 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of battery electric vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Battery electric vehicle 100 may include operator I/O device 135. Operator I/O device 135 may enable an operator of the vehicle to communicate with battery electric vehicle 100 and/or powertrain controller 150. Analogously, operator I/O device 135 enables battery electric vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter or other interface for transmission 112, a cruise control input setting, a navigation input setting, or other settings or adjustments available to the operator. Via operator I/O device 135, powertrain controller 150 can also provide commands, instructions, and/or information to the operator or a passenger.

Battery electric vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115. Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 150 is structured to receive data (e.g., instructions, commands, signals, values, etc.) from one or more of the components of battery electric vehicle 100 as described herein via the communicable coupling of powertrain controller 150 to the systems and components of battery electric vehicle 100. In some embodiments, an additional or alternative controller may be used for receiving data from certain systems or components.

In vehicles including charge system 134, such as a plug-in charging system, battery electric vehicle 100 may powertrain controller 150 may control charging of battery 132 when a charger 160 of charge system 134 is connected to battery electric vehicle 100. A charge controller 162 establishes communications between powertrain controller 150 and charger 160. Charge controller 162 may receive a charge command from powertrain controller 150 and charger 160. Charge controller 162 may monitor sensor signals and perform safety and performance checks and determine faults based thereon. For example, charge controller 162 may determine a fault if charging has started but a physical connection between charger 160 and battery electric vehicle 100 fails to be detected or is detected to be outside safe boundaries. In other words, charge controller 162 may function as a communication interface between charger 160 and powertrain controller 150.

Powertrain controller 150 may be communicably coupled with charge controller 162, battery 132 and a reporting accessory 164 so that digital data may be transferred between components. Reporting accessory 164 may be include a vehicle subsystem 140 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 164 may be operable to communicate information to powertrain controller 150. Such information may include identification, current demand, high or low voltage power draw, and other information required for operation of battery electric vehicle 100. Identification information may include a maximum current capacity of reporting accessory 164, for example. The current demand may be dynamic, such that the current demanded by reporting accessory 164 varies. Reporting accessory 164 may include an air-conditioning system, for example, and the current demand may vary based on a measured actual temperature of an interior of battery electric battery 100 compared to a target temperature. By reporting current demand to powertrain controller 150, reporting accessory 164 enables powertrain controller 150 to more accurately determine the target current to generate the charge command to charge controller 162, and, thereby, to charger 160. Comparatively, when the load of a non-reporting accessory is dynamic and unknown, charger 160 may under deliver current to battery 132 via charge controller 162, extending charging time. The charge command may also take into account the charger's capability to deliver current and indicates to charger 160 via charge controller 162 the level of current to output to battery electric vehicle 100, which is ideally sufficient to optimally charge battery 132 and also power the accessories.

Battery 132 may include one or more battery packs including a battery management unit 166 and battery modules 168. FIG. 1 is not determinative of the number of battery modules within a battery pack or the number of battery packs within battery 132. Battery 132 may include a greater number of battery packs and/or a greater or lesser number of battery modules.

Temperature, voltage, and other sensors may be provided to enable battery management unit 166 to manage the charging and discharging of battery modules 168 without exceeding their limits, to detect and manage faults, and to perform other known functions. Battery management unit 166 may transmit data to powertrain controller 150 related to information about battery 132, including the battery charge power limit, temperature, faults, etc. Battery 132 may include a current sensor to provide a measured current value to battery management unit 166, which may be used to affect the charge command provided to charge controller 162 and charger 160. The current sensor may be located elsewhere. Multiple current sensors may be used, each current sensor associated with a battery module of battery 132, where the sum of the measured currents being the measured current of battery 132.

Powertrain controller 150 may include a charge logic operable to determine a command for charge controller 162 and charger 160 to supply a target current to battery 132. The charge logic may also be integrated with a controller of battery management unit 166 or provided in a standalone controller communicatively coupled to powertrain controller 150. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle.

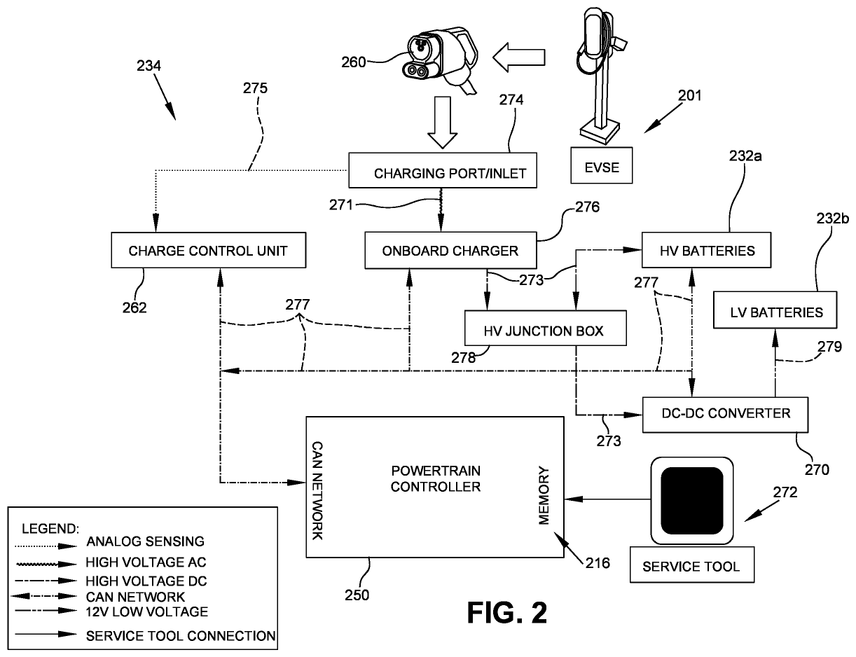

FIG. 2 briefly illustrates a schematic charge system 234 configured for use with the methods described herein. Charge system 234 includes a charger, e.g., an electric vehicle supply equipment station (EVSE) 201 and an accompanying charging cord and plug 260 configured for charging a battery 232 or batteries of a vehicle. EVSE station 201 may be configured to provide 120V AC (Level-1) output voltage. In other embodiments, EVSE station 201 may be configured to provide 208V to 240V AC (Level-2) output voltage. In yet other embodiments, EVSE station 201 may be configured to provide DC output voltage (DC Fast Charging). In still other embodiments, EVSE station 201 may be configured to provide another output voltage compatible with a corresponding battery electric vehicle (e.g., battery electric vehicle 100). Charge system 234 further includes a powertrain controller 250 in communication with battery 232 or batteries, a memory 216, a charging control unit, or charge controller 262, and a DC-DC converter 270 to facilitate the execution of the methods as described further herein. A user interface 272 may be used to access memory 216 for selective indication of predetermined thresholds and/or other calibratable metrics, as well as access recorded metrics and/or other events from memory 216.

Charge system 234 as illustrated is intended to be schematic in nature and is not intended to impart any particular structure to its components. For example, charging cord and plug 260 as described herein is intended to encompass any charger that is compatible for charging of a vehicle by coupling the EVSE station 201 with the vehicle, whether such connection is wired or wireless. Additionally, while user interface 272 is illustrated as a tablet, this is not intended to be indicative of a necessary user interface structure for use with charge system 234. In other words, user interface 272 as described herein is intended to encompass any user interface capable of carrying out the functions as described further herein. Furthermore, user interface 272 may encompass one device or may include several devices, and/or user interface 272 may comprise or consist of operator I/O device 135 as described above.

As mentioned above, charging cord and plug 260 is configured to operatively couple EVSE station 201 with the corresponding vehicle via a charging port or inlet 274 and an onboard charger 276. Inlet 274 is configured to receive charging cord and plug 260 to connect the corresponding vehicle with an external power supply, such as EVSE station 201, to facilitate charging of high voltage battery 232a. Onboard charger 276 may, in embodiments where the vehicle receives an AC-input charger, convert high voltage AC input power 271 (e.g., single-phase AC mains and star or delta three-phase power) from external sources (e.g., EVSE station 201) to high voltage DC output power 273 to facilitate charging of high voltage battery 232a.

Charge controller 262 is in communication with inlet 274 to facilitate monitoring of circuits such as proximity and/or connection of charging cord and plug 260 with inlet 274 and validity of said connection of charging cord and plug 260 with inlet 274 via analog sensing 275. Charge controller 262 may be configured to exchange data with EVSE station 201 via inlet 274 and charging cord and plug 260 to determine if charging is safe to start or stop and what level of power is capable of being delivered. Charge controller 262 may also or alternatively be configured to exchange data with powertrain controller 250 via a controller area network (CAN bus 277) to obtain voltage, current targets, and readiness of the corresponding vehicle to receive power transfer from EVSE station 201. Charge controller 262 may also or alternatively be configured to manage peripheral systems such as a locking motor and/or indicators.

High voltage junction box 278 receives high voltage DC output power 273 from onboard charger 276 and redistributes high voltage DC output power 273 to DC-DC converter 270 and/or high voltage batteries 232a as needed. High voltage junction box 278 may also be configured to route high voltage DC output power to other devices, such as a traction motor of the corresponding vehicle. High voltage batteries 232a receive, store, and distribute power to a differential (e.g., wheels) of the corresponding vehicle. High voltage batteries 232a may additionally or alternatively provide power to accessories such as compressors or pumps (e.g., HVAC of the corresponding vehicle, braking systems of the corresponding vehicle, pumps routing coolant to various components, and/or power steering). High voltage batteries 232a may also accept energy when charged from an external power source, such as EVSE station 201 via charging cord and plug 260 as described above, or during regenerative braking events.

DC-DC converter 270 is configured to convert high voltage DC output power 273 received from high voltage junction box 278 to a lower voltage suitable for maintaining the low voltage bus required by various controllers and/or systems for wakeup and/or ignition needs of said controllers and/or systems. For example, DC-DC converter 270 may receive 600-700V of DC power and convert said power to a lower voltage such as 48V, 24V, 12V, or another suitable voltage for the corresponding controllers and/or systems of the corresponding vehicle. Low voltage batteries 232b are configured to receive converted low voltage DC output power 279 from DC-DC converter 270 and store and/or distribute said power as required by the corresponding vehicle and corresponding systems and/or controllers. For example, low voltage batteries 232b may provide power to a battery controller, a DC-DC converter controller, onboard charger 276, charge controller 262, or other controllers or systems of the corresponding vehicle. Low voltage batteries 232b receive, store, and distribute power according to the needs of said controllers or systems and are maintained at a predetermined voltage setpoint which allows for wakeup, operation, and shutdown of required controllers and/or systems.

Memory may be integrated with power train controller 250. In some embodiments, an external memory may be used in execution of the methods and functions discussed further herein. Powertrain controller 250 is coupled to at least charge controller 262, onboard charger 276, DC-DC converter 270, and high voltage batteries 232a via CAN bus 277. Powertrain controller 250 may include embedded algorithms to facilitate real-time functions such as vehicle propulsion, regenerative braking, safety mechanisms, charging, and additional functions required or desired for function of the corresponding vehicle. CAN bus 277 may be a dedicated CAN bus 277 to facilitate interfacing between powertrain controller 250 with the remaining components. Powertrain controller 250 may be configured to exchange information via reception and transmission with each of these components via CAN bus protocol, arbitrate the steps to take, and send commands to said components according to driver inputs.

Schematic charging systems 134, 234 as described above may have interchangeable components where consistent and/or capable of interchangeability to carry out the functions and/or methods as described further herein. In other words, charging system 134 and charging system 234 may be considered consistent embodiments, and the description of the systems and methods further herein using “2” reference numbers may also be applied to the system illustrated and described in reference to FIG. 1 above.

Restarting or resuming an AC charging session as needed without disconnecting and reconnecting the charger increases vehicle uptime by increasing the chance that the battery or batteries of the vehicle are at or near top-of-charge when needed. This prevents the need to manually disconnect and reconnect the charger to reach top-of-charge in the event that power to the charging station is momentarily lost and subsequently restored, the charge session faulted due to an intermittent condition that was subsequently resolved, or the charge session ended after reaching top-of-charge, but the available state-of-charge dropped due to parasitic draw to vehicle systems and/or accessories. Additionally, inhibiting powertrain controller shutdown at the end of a charging session by actively commanding that the battery connectors remain closed and enabling the DC-DC converters to regulate a low voltage battery voltage at a setpoint mitigates low voltage battery drain after the charging session ends.

Referring to FIGS. 2 (reference numbers beginning with “2”) and 3 (reference numbers beginning with “3”), an illustration of a method of restarting or resuming a charging session is illustrated by graph 300. Indicator line 302 illustrates the available state-of-charge along the y-axis of graph 300 over time along the x-axis of graph 300, wherein the course of indicator line 302 illustrates the state-of-charge during a charging session. The illustrated course of indicator line 302 is meant for illustrative purposes only. The course of a charging session may not follow the same or even a similar course to that illustrated. In such instances, the system and method may still be operated as described herein. Similarly, the passage of time illustrated by the x-axis should not be limited to any specific time parameters, as the system and method described herein may be applied whether the charging session occurs over a matter of seconds, minutes, hours, days, etc.

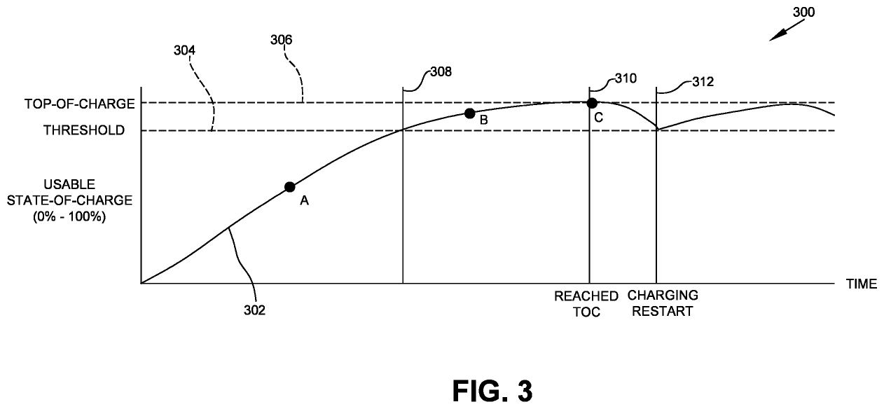

A predetermined threshold state-of-charge value, illustrated by indicator line 304, may be set by an operator and stored in memory 216 to be accessed by powertrain controller 250 as described further herein. The threshold state-of-charge value may, as illustrated, be below top-of-charge, illustrated by indicator line 306. The threshold state-of-charge value may, for example, be set at a level which would allow a corresponding vehicle to complete any required or desired route(s) or mission(s) between charging sessions. The threshold state-of-charge value as indicated by indicator line 304 is meant for illustrative purposes only. The threshold state-of-charge may be set higher or lower than the threshold state-of-charge illustrated by FIG. 3.

Milestone marker 308 highlights the point at which available state-of-charge 302 crosses threshold state-of-charge value 304 during the charging session. Milestone marker 310 highlights the point at which available state-of-charge 302 reaches top-of-charge 306. Milestone marker 312 highlights the point at which available state-of-charge 302 meets or decreases below threshold state-of-charge value 304, triggering a charging session restart as described further herein.

When an AC charging session ends, as long as EVSE station 201 remains connected to the vehicle via charging cord and plug 260, the steps taken to restart the session vary depending on available state-of-charge 302 at the point of termination. If the charging session terminates when available state-of-charge 302 is at a value below threshold state-of-charge value 304, for example, point A, the session will attempt to restart. If the attempt is successful, the charging session resumes and available state-of-charge 302 begins to increase toward top-of-charge 306 again. If the attempt to restart fails, a calibratable amount of time, set by an operator and stored in memory 216 to be accessed by powertrain controller 250, is allowed to lapse to allow time for any issue or issues preventing the session from restarting to resolve itself or themselves. Particularly, a hardcoded false signal is fed from powertrain controller 250 of the corresponding vehicle to an interface parameter or other appropriate component to give sufficient time for the issue(s) to resolve. If the calibratable amount of time expires and the issue(s) remain unresolved, powertrain controller 250 is permitted to power down.

Point A of FIG. 3 is meant for illustrative purposes only. If the charging session terminates when the available state-of-charge value is at any value below the threshold state-of-charge value, the same steps are taken to restart or resume the charging session as described in relation to Point A. If the charging session terminates when available state-of-charge 302 is at a value above threshold state-of-charge value 304 but below top-of-charge 306 (e.g., point B), or if the charging session terminates once available state of charge 302 reaches top-of-charge 306 (e.g., point C), powertrain controller 250 inhibits shutdown and commands battery contactor(s) of the corresponding high voltage battery or batteries 232a to stay closed. Powertrain controller 250 commands DC-DC converter 270 to regulate the voltage of low voltage battery or batteries 232b at a predetermined setpoint, set by an operator and saved to memory 216.

After termination of the charging session, parasitic draw to vehicle systems may deplete available state-of-charge 302 of high voltage battery or batteries 232a of the corresponding vehicle 206, as illustrated by indicator line 302 between milestone marker 310 and milestone marker 312. If available state-of-charge 302 drops below threshold state-of-charge 304, powertrain controller 250 will attempt to restart the charging session. If the restart attempt fails, a calibratable amount of time is allowed to lapse to allow time for any issue or issues preventing the session from restarting to resolve itself or themselves. If the calibratable amount of time expires and the issue(s) remain unresolved, powertrain controller 250 is permitted to power down. Point B and point C of FIG. 3 are meant for illustrative purposes only. If the charging session terminates when the available state-of-charge value is at any value above the threshold state-of-charge value and below top-of-charge, the same steps are taken to restart or resume the charging session as described in relation to point B. All of the above-mentioned actions are taken automatically without operator intervention. In other words, operator action is not required to attempt charging session restart given the conditions described above and further herein.

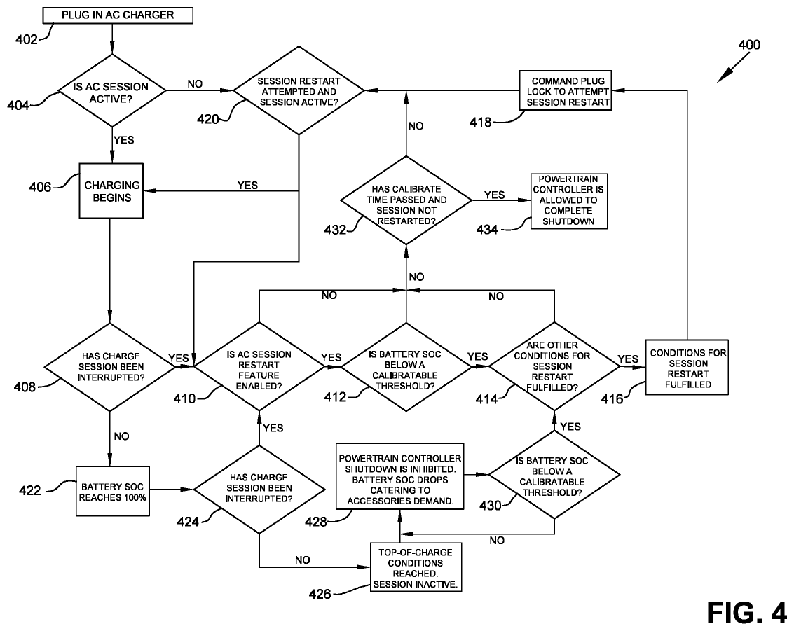

Now referring to FIG. 4 (reference numbers beginning with “4”) and FIG. 2 (reference numbers beginning with “2”), a method 400 for managing an AC charging session using charge system 234 is illustrated. The method begins at box 402 when EVSE station 201 is connected to the corresponding vehicle via charging cord and plug 260. At box 404, powertrain controller 250 of charge system 234 is configured to determine if the AC charging session is active. In particular, in some embodiments, powertrain controller 250 determines that the charging session is active when a charge controller 262 recognizes the presence of AC single-phase high voltage at input terminals of charging cord and plug 260, valid communication with EVSE station 201 via charging cord and plug 260, and charging consent provided by the vehicle. In other words, powertrain controller 250 may determine that a charging session is active upon receiving indicative signal(s) from onboard charger 276 via charge controller 262.

If the charging session is active, charging begins at box 406. At box 408, powertrain controller 250 is configured to determine whether the charging session has been interrupted. In particular, in some embodiments, the charging session is determined to have been interrupted if the charge consent of the vehicle is no longer true and/or has changed from true to false. If the charging session has been interrupted, powertrain controller 250 is configured to determine whether a session restart feature is enabled at box 410. The session restart feature may be enabled and/or disabled via calibration (i.e., “true” for enablement). If the session restart feature is enabled, powertrain controller 250 is configured to determine whether an available state-of-charge of high voltage battery or batteries 232a of the corresponding vehicle is below a predetermined threshold, as discussed above in relation to FIG. 3, at box 412. In other words, once powertrain controller 250 determines enablement of the session restart feature, the state-of-charge of the high voltage battery or batteries 232a is received and compared to the predetermined threshold retrieved from memory 216 to determine whether the state-of-charge is above or below the predetermined threshold. The predetermined threshold is calibratable by a user or operator and stored in memory 216 to reflect a state-of-charge level which allows the vehicle to complete a subsequent mission.

If the available state-of-charge is below the predetermined threshold, powertrain controller 250 is configured to determine if other conditions for a charging session restart are fulfilled at box 414. The other conditions may, for example, include continued connection of the vehicle to EVSE station 201 via charging cord and plug 260, continued closure of the battery contactors, and other conditions which may be necessary for function of a restarted charging session. The other conditions may, for example, also include passage of the calibratable amount of time to allow for self-resolution of potential fault or other issue resulting in termination of the charging session, especially where an operator or other user intentionally unlocks charging cord and plug 260 when high voltage battery or batteries 232a are at a state-of-charge below the predetermined threshold. In such an event, the calibratable amount of time may be allowed to pass to allow the operator or user to disconnect EVSE station 201 and/or charging cord and plug 206. If the other conditions are fulfilled at box 416, powertrain controller 250 commands a session restart attempt at box 418. If charging cord and plug 260 is unlocked but remains connected (i.e., if the charger is not disconnected within the calibratable amount of time), powertrain controller 250 commands charging cord and plug 260 to lock as a first step of the restart attempt. Powertrain controller 250 is configured to determine whether the charging session restart was attempted and if the session is active at box 420. In particular, in some embodiments, the charging session is determined to have been active if the charge consent of the vehicle is true and/or has changed from false to true. If the restart session was attempted and active, charging begins at box 406. The method continues as described above and further herein. If the restart session was not attempted or the restart session was attempted and not active, powertrain controller 250 is configured to determine if the session restart feature is enabled at box 410. The method continues as described above and further herein.

If, at box 404, powertrain controller 250 determines that the charging session is not active, powertrain controller 250 is configured to determine whether the charging session restart was attempted and if the session is active at box 420. If the restart session was attempted and active, charging begins at box 406. The method continues as described above and further herein.

If, at box 408, powertrain controller 250 determines that the charge session has not been interrupted, the charging session continues until the available state-of-charge of high voltage battery or batteries 232a of the corresponding vehicle reaches top-of-charge at box 422. Powertrain controller 250 is configured to determine if the charge session was interrupted at box 424. If the charge session has been interrupted, powertrain controller 250 is configured to determine whether the session restart feature is enabled at box 410. The method continues as described above and further herein. If powertrain controller 250 determines the charging session has not been interrupted, e.g., if a fault is not discovered and/or if high voltage battery or batteries 232a transmit a signal indicating a full charge has been reached, it is concluded that top-of-charge conditions have been reached and the charging session is considered inactive at box 426. After top-of-charge conditions are reached, shutdown of powertrain controller 250 is inhibited at box 428 by powertrain controller 250 commanding charge controller 262 to retain an auxiliary keyswitch input to powertrain controller 250 to prevent shutdown. Over time, parasitic draw may deplete the available state-of-charge of high voltage battery or batteries 232a of the corresponding vehicle. Powertrain controller 250 is configured to determine if the available state-of-charge of high voltage battery or batteries 232a of the corresponding vehicle is below the predetermined threshold at box 430, as discussed above. If the available state-of-charge is equal to or above the predetermined threshold, shutdown of powertrain controller 250 continues to be inhibited and parasitic draw to vehicle systems may continue to deplete the available state-of-charge at box 428. If the available state-of-charge is below the predetermined threshold at box 430, powertrain controller 250 is configured to determine if other conditions, as discussed above, for session start are fulfilled at box 414. The method continues as described above and further herein.

If, at box 410, powertrain controller 250 determines the session restart feature is not enabled, powertrain controller 250 is configured to determine whether the calibratable time, as discussed above, has passed and the session has not restarted at box 432. If the session has restarted before the calibratable time has passed, the method continues to box 420 as described above and the method continues. If the calibratable time has passed and the session has not restarted, powertrain controller 250 is permitted to complete shutdown at box 434.

If, at box 412, powertrain controller 250 determines the available state-of-charge of high voltage battery or batteries 232a of the corresponding vehicle is equal to or above the predetermined threshold, powertrain controller 250 is configured to determine whether the calibratable time has passed and the session has not restarted at box 432. If the session has restarted before calibratable time has passed, the method continues to box 420 as described above and the method continues as described above. If the calibratable time has passed and the session has not restarted, the powertrain controller 250 is permitted to complete shutdown at box 434.

If, at box 414, powertrain controller 250 determines the other conditions for session restart are not fulfilled, the system is configured to determine whether the calibratable time has passed and the session has not restarted at box 434. If the session has restarted before the calibratable time has passed, the method continues to box 420 as described above and the method continues as described above. If the calibratable time has passed and the session has not restarted, powertrain controller 250 is permitted to complete shutdown at box 434.

Method 400 continues along any of the given paths described above in response to system logic until powertrain controller 250 is permitted to complete shutdown at box 434 or EVSE station 201 is disconnected from the corresponding vehicle. Termination of the charging session as described herein may result from a fault or other non-fault reasons, including, for example, ending the charging session when the state-of-charge reaches top-of-charge and other events when the charging session is intentionally ended, for example, by disconnecting the charger, releasing the parking brake, etc.

Diagnosing why a charging session ends is important for solving and repairing faults in a vehicle system, which in turn allows for more successful and efficient vehicle use and vehicle longevity. Efficiently determining the initial reason a charging session is ended allows for easy diagnosis of any faults or errors, which significantly improves troubleshooting efforts and solutions, resulting in increased vehicle uptime. Identifying chronic issues similarly allows for improved troubleshooting and repair.

A charge session tracking system discussed herein registers and records a plurality of metrics to assist with identification of chronic issues and/or initial faults occurring during charging sessions of a corresponding vehicle or fleet of vehicles. The plurality of metrics may include, for example, the charging session number, the charging session end reason in text, the charging session type (i.e., AC or DC), the duration of time the corresponding vehicle was connected to the charger (e.g., in minutes), the duration of the active charging session (e.g., in minutes), the net state-of-charge change (e.g., in percentage), the net energy delivered (e.g., in kWh), the duration of active charge (e.g., in minutes), the duration of delayed charge (e.g., in minutes), and/or the duration of discharge (e.g., in minutes). Any combination of the above metrics may be used, as well as additional metrics not explicitly listed herein.

In some embodiments, each of the plurality of metrics may be considered “mandatory” or “optional” by the system according to operator settings. For example, each of the charging session number, the charging session end reason, the charging session type, the duration of the active charging session, the net state-of-charge change, and the duration of active charge may be considered particularly necessary or helpful in diagnosing errors or faults of the charging system and are therefore input as “mandatory”. The net energy delivered, the duration of time the corresponding vehicle was connected to the charger, the duration of delayed charge, and the duration of discharge may be considered helpful but not necessary and are therefore input as “optional”. Mandatory metrics are easily accessible and immediately visible on a user interface for field use. Optional metrics are able to be stored for optional viewing as needed when further information for each corresponding charging session is desired. The list of “mandatory” and “optional” metrics described herein are for illustrative purposes only. An operator may designate any metric as “mandatory” or “optional” as befits the need of the operator using, for example, user interface 272.

In some embodiments, any combination of the plurality of metrics may be selected for display on the user interface 272 for field use without designation of “mandatory” or “optional”. In any embodiment, the system may calculate and/or record every metric but only display the metric considered mandatory or otherwise chosen for display.

The metrics may be retrieved from memory 216 by an operator using user interface 272 to review said metrics and conduct diagnostics on the relevant vehicle or fleet of vehicles.

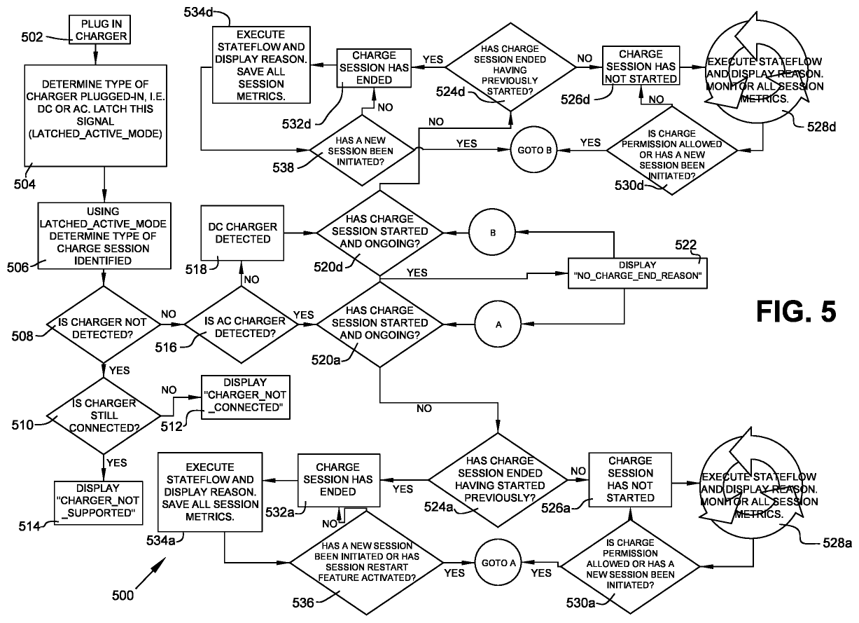

Referring to FIG. 5 (reference numbers beginning with “5”) and FIG. 2 (reference numbers beginning with “2”), a method 500 for tracking a charging session using charge system 234 of a corresponding vehicle is illustrated. The method begins at box 502 when EVSE station 201 is connected to the corresponding vehicle via charging cord and plug 260 as discussed above. The system records in corresponding memory 216 the number of charge session being initiated (i.e., the first (“1”), the second (“2”), the third (“3”), etc.). Powertrain controller 250 may receive an input from EVSE station 201 and/or charging cord and plug 260 indicating what type of charger has been connected (i.e., DC or AC) at box 504. The input is used to identify the type of charge session at box 506. If powertrain controller 250 does not recognize the charger input at box 508, powertrain controller 250 is configured to determine if EVSE station 201 remains connected at box 510, e.g., powertrain controller 250 is configured to determine that EVSE station 201 is connected if powertrain controller 250 continues to receive inputs from charge controller 262 indicating the charger connection is still present; powertrain controller 250 is configured to determine that EVSE station 201 is no longer connected if powertrain controller 250 receives inputs from charge controller 262 indicating the charger connection is no longer present. If EVSE station 201 is no longer connected, powertrain controller 250 records in corresponding memory 216 that EVSE station 201 is not connected in readable or plain text (e.g., “CHARGER_NOT_CONNECTED” or a similar text that is easily discernible) under the charging session end reason metric at box 512. If EVSE station 201 is connected but powertrain controller 250 does not recognize EVSE station 201 and/or charging cord and plug 260 at box 508, powertrain controller 250 records in memory 216 that EVSE station 201 and/or charging cord and plug 260 is not recognized or supported in readable or plain text (e.g., “CHARGER_NOT_SUPPORTED” or a similar text that is easily discernible) under the charging session end reason metric at box 514.

If powertrain controller 250 recognizes the charger input at box 508, powertrain controller 250 records in memory 216 either an AC charge session (e.g., “AC” or a similar text that is easily discernible) under the charge session type metric at box 516 or a DC charge session (e.g., “DC” or a similar text that is easily discernible) under the charge session type metric at box 518. Method 500 as described further herein has a similar pathway regardless of the charge session type. As such, the remainder of method 500 will only be described once but referencing multiple method boxes, as the method is the same regardless of charge session type once said charge session type has been established at box 516 or 518. Each similar box is labeled with the same reference number but is designated with an “A” for the “AC” path or a “D” for the “DC” path. Deviations from the shared path are otherwise disclosed.

Powertrain controller 250 is configured to determine if the charging session has begun and is ongoing at box 520A, 520D. In particular, in some embodiments, the corresponding vehicle charge consent is “true” when the charging session is ongoing, which is communicated to powertrain controller 250 for confirmation that the charging session is active. If the charge session has begun and is ongoing, powertrain controller 250 records in memory 216 that the charge session has not ended in readable or plain text (e.g., “NO_CHARGE_END_REASON” or a similar text that is easily discernible) under the charging session end reason metric at box 522. This text may remain in memory 216 until the charging session ends and powertrain controller 250 records a different reason under the charging session end reason (i.e., when the charging session ends). In other words, the method may return to box 520A, 520D in a loop until powertrain controller 250 determines that the charge session is not ongoing as discussed further herein.

If powertrain controller 250 determines that the charge session is not ongoing at box 520A, 520D, powertrain controller 250 is configured to determine if the charging session ended after having previously started at box 524A, 524D. In other words, powertrain controller 250 is configured to determine if active charging has been interrupted, via the vehicle charge consent input as described above, and restarted, via the vehicle charge consent input and/or recognition of a new charger connection event, during the charging session or if active charging has not begun at all during the charging session.

If, at box 524A, 524D, powertrain controller 250 determines that active charging has not begun during the charging session, illustrated at box 526A, 526D, powertrain controller 250 commands the execution of a stateflow containing sequential decision logic 528A, 528D, e.g., an if/else logic loop, to determine the reason for nonstart of active charging. For example, execution of the stateflow may include determination of whether battery contactors are closed, whether EVSE station 201 and/or charging cord and plug 260 is connected, whether the OEM has disabled charging, etc. In other words, stateflows 528A, 528D include a systematic check of various vehicle systems to determine whether any particular events, faults, or settings, have resulted in nonstart of active charging. If, during execution of stateflows 528A, 528D, the reason for nonstart of active charging is determined, powertrain controller 250 records in memory 216 the reason for nonstart of active charging and displays the reason in real-time. Stateflows 528A, 528D are executed repeatedly until powertrain controller 250 determines that a charge permission has been allowed or a new session has been initiated at box 530A, 530D, e.g., via the vehicle charge consent input and/or recognition of a new charger connection event. In other words, as long as powertrain controller 250 does not detect that a charge permission has been allowed or a new session has been initiated at box 530A, 530D, it is identified that active charging has not begun during the charging session at box 526A, 526D, and stateflows 528A, 528D continue to be executed. During execution of stateflows 528A, 528D, other session metrics described herein are continuously monitored and updated by powertrain controller 250.

In some embodiments, if powertrain controller 250 identifies that a charge permission has been allowed or a new session has been initiated at box 530A, 530D, method 500 returns to box 520A, 520D, where powertrain controller 250 is configured to determine if the charge session has begun and is ongoing as discussed above.

If, at box 524A, 524D, powertrain controller 250 determines that active charging has ended after having previously started, illustrated at box 532A, 532D, powertrain controller 250 commands the execution of stateflows 534A, 534D to determine the reason for active charging termination. Similar to stateflows as described above, execution of stateflows may include determination of whether battery contactors are closed, whether EVSE station 201 and/or charging cord and plug 260 is connected, whether the OEM has disabled charging, etc. In other words, stateflows 528A, 528D include a systematic check of various vehicle systems to determine whether any particular events, faults, or settings, have resulted in termination of active charging. However, stateflows 534A, 534D are executed a single time, and powertrain controller 250 records the identified reason for termination of active charging in the corresponding memory. In addition to recording the identified reason for termination of active charging in the corresponding memory, powertrain controller 250 also saves to memory all of the remaining session metrics described herein.

A “failure of active charging” may refer to either a nonstart of active charging or a termination of active charging.

If method 500 is being executed for an AC charging session, powertrain controller 250 is configured to determine at box 536 if a new session has been initiated, via the vehicle charge consent input and/or charger connection event, or if a session restart feature is enabled and active (e.g., the session restart feature described above in relation to FIGS. 2 and 3). If the session restart feature is enabled or if a new session has been initiated, method 500 returns to box 520A, where powertrain controller 250 is configured to determine if the charge session has begun and is ongoing as discussed above. The method continues as described above. If the session restart feature is not enabled and a new session has not been initiated, it is identified that active charging has ended at box 532A. The method may continue as described above.

If method 500 is being executed for a DC charging session, powertrain controller 250 is configured to determine at box 538 if a new session has been initiated, via the vehicle charge consent input and/or charger connection event. If a new session has been initiated, method 500 returns to box 520D, where powertrain controller 250 is configured to determine if the charge session has begun and is ongoing as discussed above. The method may continue as described above. If a new session has not been initiated, it is identified that active charging has ended at box 532D. The method continues as described above.

The return to box 520A, 520D from any of boxes 530A, 530D, 536, 538 results in the recording of a new charging session. In other words, if the initial connection of EVSE station 201 and/or charging cord and plug 260 initiated charging session “1”, the reason for failure of active charging and/or termination of active charging is determined and recorded under charging session “1”, and the return to box 520A, 520D initiates charging session “2”. In such an embodiment, the information recorded to charging session “1” is imparted to charging session “2”, wherein the reason for failure of active charging and/or termination of active charging for charging session “2” is able to be recorded separately from charging session “1”, and so on, until the charger is disconnected and reconnected (i.e., a charging session “3” may begin with all metrics blank and ready for recordation).

The system may record up to 30 separate charging sessions and their corresponding metrics. In other embodiments, the system may record up to 10 separate charging sessions, up to 20 separate charging sessions, up to 40 separate charging sessions, up to 50 separate charging sessions, up to 60 separate charging sessions, and so on. As charging sessions are saved to memory, the oldest set of metrics are removed from memory first as the allotted space for saving charging sessions is met, using a first-in-first-out queue approach.

In some embodiments, method 500 and corresponding system may be applied to a fleet so that charging sessions across a fleet of vehicles, for example, may be accessed and reviewed. The recorded metrics as described herein can be viewed for each vehicle within the fleet and compared to determine whether patterns of charging sessions and/or issues related to charging sessions exist across the fleet rather than being isolated to one vehicle.

### EXAMPLE

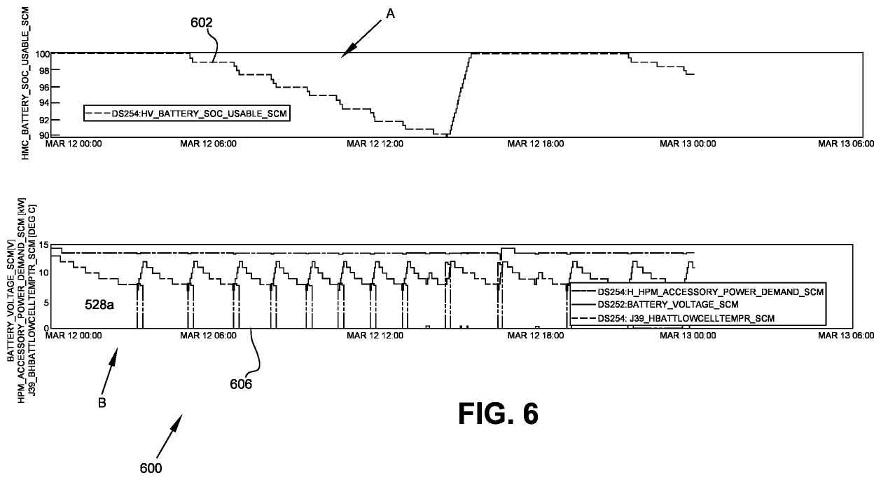

Referring now to FIG. 6, a charging event was initiated by connecting a vehicle to a charger at 0000 hours on Mar. 12, 2022. The vehicle remained connected to the charger until 0600 hours on Mar. 13, 2022. The charging system as described above in relation to FIGS. 2 and 3 was applied to the vehicle throughout the charging event. A state-of-charge of a battery of the vehicle is illustrated over the time of the charging event in subplot A by indicator line 602. In subplot B, battery cell temperature over the time of the charging event is illustrated by indicator line 604 and accessory power demand is illustrated by indicator line 606.

As discussed above, once the available state-of-charge of a battery of a vehicle reaches top-of-charge, shutdown of the powertrain controller of the charge system is inhibited. When battery cell temperature begins to drop, battery heaters are commanded to run and thermally regulate the cell temperatures in an optimum temperature range. This is evidenced in subplot B—accessory demand power peaks when the battery heaters are commanded to operate, and the accessory power demand drops to or near zero when the cell temperatures are within the optimum temperature range.

Due to the repeating peak of accessory power demand, the available state-of-charge illustrated in subplot A drops below the predetermined 90% threshold. Once the available state-of-charge drops below the threshold, the charging session restart feature is attempted and, once the session is activated, charging of the vehicle begins and the available state-of-charge raises back to top-of-charge.

While the system and methods herein have been described by reference to various specific embodiments it should be understood that numerous changes may be made within the spirit and scope of the concepts described, accordingly, it is intended that the invention is not limited to the described embodiments but will have full scope defined by the language of the following claims.

What is claimed is:

1. A charge system for restarting an AC charging session, the charge system comprising:
a controller, the controller configured to:
receive a first input identifying a charge session interruption;
receive a second input identifying an available state-of-charge of a battery;
compare the available state-of-charge of the battery with a predetermined threshold; and
transmit a first output to command a first attempt to restart the charge session when the available state-of-charge of the battery is less than the predetermined threshold.

2. The charge system of claim 1, wherein the controller is configured to continuously receive the second input identifying the available state-of-charge of the battery.

3. The charge system of claim 1, wherein, when a first attempt to restart the charge session fails, the controller is configured to allow a calibratable amount of time to lapse before transmitting a second output to initiate a second attempt to restart the charge session.

4. The charge system of claim 3, wherein the controller is configured to feed a hardcoded false output to an interface parameter for the calibratable amount of time to inhibit controller shutdown.

5. The charge system of claim 3, wherein, when the second attempt to restart the charge session fails, the charge system is configured to allow shutdown of the controller.

6. The charge system of claim 1, further including a charger having a locked position and an unlocked position, wherein the charger is in the locked position when the controller transmits the first output.

7. The charge system of claim 1, wherein the charge system is configured to operate with one or more fuel cell electric vehicles.

8. A charge system for mitigating low voltage battery depletion, the charge system comprising:
a powertrain controller, the powertrain controller configured to:
receive a first input identifying a charge session termination;
receive a second input identifying an available state-of-charge of a battery;
compare the available state-of-charge of the battery with a predetermined threshold; and
when the available state-of-charge of the battery is higher than the predetermined threshold, transmit a first output commanding a charge controller to retain an auxiliary keyswitch input to inhibit shutdown of the powertrain controller.

9. The charge system of claim 8, wherein the powertrain controller is configured to transmit a second output commanding contactors of the battery to remain closed.

10. The charge system of claim 8, wherein the powertrain controller is configured to transmit a third output commanding a DC-DC converter to regulate a voltage of a low voltage battery at a predetermined setpoint.

11. The charge system of claim 8, wherein the powertrain controller is configured to continuously receive the first input identifying the available state-of-charge of the battery.

12. The charge system of claim 11, wherein the powertrain controller is configured to identify an event in which the available state-of-charge of the battery is depleted beneath the predetermined threshold.

13. The charge system of claim 12, wherein the powertrain controller is configured to transmit a fourth output to attempt to restart the charge session when the available state-of-charge of the battery is less than the predetermined threshold.

14. A charge system for tracking metrics of a charging session, the charge system comprising:
a controller; and
a memory;
wherein the controller is configured to:
receive a first input identifying a failure of a charging session;
execute a stateflow to identify a reason for the failure of the charging session; and
record the reason for the failure of the charging session in the memory with plain text.

15. The charge system of claim 14, wherein the failure of the charging session is a result of an unexpected termination of the charging session.

16. The charge system of claim 14, wherein the controller is configured to further identify at least one of: a charging session type, a charging session number, a duration of an active charging session, a net state-of-charge change, a duration of active charge, a measurement of net energy delivered into high voltage batteries, a duration of connection to a charger, a duration of delay of the charging session, and a duration of discharge.

17. The charge system of claim 16, wherein the controller is configured to identify ten metrics of the charging session.

18. The charge system of claim 17, wherein the controller is configured to record the metrics in an array.

19. The charge system of claim 14, further comprising a user interface configured to access the memory and display the plain text.

20. The charge system of claim 19, wherein the user interface is configured to display the plain text for a plurality of vehicles.
